(19) United States
(12) Patent Application Publication
(10) Pub. No.: US 2013/0066682 A1
(43) Pub. Date: Mar. 14, 2013

(54) METHOD AND SYSTEM FOR DYNAMIC GEOSPATIAL MAPPING AND VISUALIZATION

(71) Applicant: Eddie Godshalk, San Jose, CA (US)

(72) Inventor: Eddie Godshalk, San Jose, CA (US)

(21) Appl. No.: 13/554,621

(22) Filed: Jul. 20, 2012

Related U.S. Application Data
(60) Provisional application No. 61/534,366, filed on Sep. 13, 2011.

(51) Int. Cl. G06Q 30/02

(52) U.S. Cl. 705/7.34

(57) ABSTRACT

A computer-implemented method for acquiring geospatial data, compiling the geospatial data and providing and interactive visual representation of the geospatial data based on user input is provided. The method acquires and evaluates geospatial data vendors providing historical geospatial data under multiple categories. The categories comprise national variables, metro market datasets, monthly/quarterly datasets, and all national property datasets. The method compiles variables from the acquired and evaluated geospatial data into individual geospatial datasets. The method loads a twenty four month geospatial forecast with statistical confidence based on mathematical processes performed on the individual geospatial datasets by a predictive engine. A user-defined, ranked or tiered weighted search comprising multiple choices is provided to the user for generating geospatial maps. The geospatial maps generated from the geospatial forecast are visually represented as heat maps. Further more, the user accesses all spatial boundary information using a spatial slider.

### CROSS-REFERENCE TO RELATED APPLICATION

This application claims benefit of priority of U.S. Provisional Patent Application Ser. No. 61/534,366, filed 13 Sep. 2011; entitled “Methods and Systems for Dynamic Geospatial Mapping and Visualization”, owned by the assignee of the present application and herein incorporated by reference in its entirety.

### FIELD OF INVENTION

The present invention relates to several techniques employed to transform the way people make home investment decisions. Using complex proprietary valuation models and spatial predictive models, the invention disclosed herein delivers home estimates and forecasts, enabling users to adequately assess risk and improve their profits. Embodiments of the invention are backed by a query-able system, a geospatial database of current datasets, and a geospatial database of latitude/longitude datasets (property datasets, for example that are clustered into a geospatial database), having outputs of dynamic heat maps and interactive reports. Embodiments of the invention also allow users to locate a desired block, track or zip code, based upon user defined tiered ranking or weighting query to, subsequently find a property.

### BACKGROUND

Traditional geospatial mapping systems provide a real estate property listing, wherein users can define a destination search area via a user interface. The destination search area would display a geographic map. The user interface of the traditional systems would also enable the user to utilize spatial and non-spatial filters to define the geographical area as disclosed in the U.S. patent application hearing application No. 12/500,576. Additional geographic information would also be provided along with the listing. The geographic information and geographic map are also created based on data convolution and color ramp as disclosed in the Canadian patent application bearing patent number 2,662,939. But neither do traditional mapping systems analyze available data to valuate real estate properties, nor do they educate users on purchasing real estate property.

In year 2010, over $1.2 trillion was transacted in the sale of existing U.S. homes using traditional valuation models that have been largely inadequate. Escalating foreclosure, mounting bank problem inventories and consumer loss of home equity have put the issue of the traditional valuation models at the forefront. Real estate investors and agents often utilize static reports based upon historical property data. The historical property data are limited to yearly, demographic and economic data. Spatial software as a service (SAAS) decision tools at the local level do not exist, and without these tools investors cannot make adequate informed decisions as to when to buy or sell the property. Hence there is a long felt unresolved need for a SAAS platform that analyzes and transforms nearest real-time data from thousands for US local and regional markets to create an effective valuation model enabling users to make adequate informed decisions.

### SUMMARY

The present invention presents a computer-implemented method for acquiring geospatial data, compiling the geospatial data and providing an interactive visual representation of the geospatial data based on user input. The computer implemented method acquires and evaluates geospatial data from one or more vendors. Each of the vendors provides historical geospatial data under multiple categories. The categories comprise national variables, metro market datasets, monthly/quarterly datasets, and all national property datasets. The computer implemented method compiles the variables from the acquired and evaluated geospatial data into individual geospatial datasets and a standard database. The geospatial datasets comprise Census Block, Census Block Group, Census Tract, Zip Codes, neighborhoods, cities, counties, metro markets and states.

The computer implemented method loads a twenty four month geospatial forecast with statistical confidence based on multiple mathematical processes performed on the individual geospatial datasets by a predictive engine. The user is provided with user-defined, ranked or tiered weighted searches comprising multiple choices for generating the dynamic geospatial maps. The dynamic geospatial maps are visually represented as heat maps. The dynamic geospatial maps are generated from the geospatial forecast. Further more, the user is allowed to slide a spatial slider. The user dynamically accesses all spatial boundary information in a report, a form, a web pages or a dynamic map.

The other objects and advantages of the embodiments herein will become readily apparent from the following detailed description taken in conjunction with the accompanying drawings.

### BRIEF DESCRIPTION OF THE DRAWINGS

FIG. 1 is a flowchart illustrating the sequence of steps for acquiring geospatial data, compiling the geospatial data and providing an interactive visual representation of the geospatial data based on user input.

FIG. 2 illustrates a system for loading of geospatial data.

FIG. 3 illustrates color distributions within dynamic heat maps

FIG. 4 illustrates color distributions with a metro market of 600 Census Block Groups within dynamic heat maps.

FIG. 5 illustrates different types of geospatial sliders

FIG. 6 depicts geospatial maps drawn in real time.

FIG. 7 depicts ranked or user-defined weighted tiered query.

FIG. 8 depicts dynamic heat maps comprising one geospatial slider for user-defined interactive reports.

FIG. 9 depicts dynamic heat maps comprising two geospatial sliders for user-defined interactive reports.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present invention describes a computer-implemented method for acquiring geospatial data, compiling the geospatial data and providing and interactive visual representation of the geospatial data based on user input.

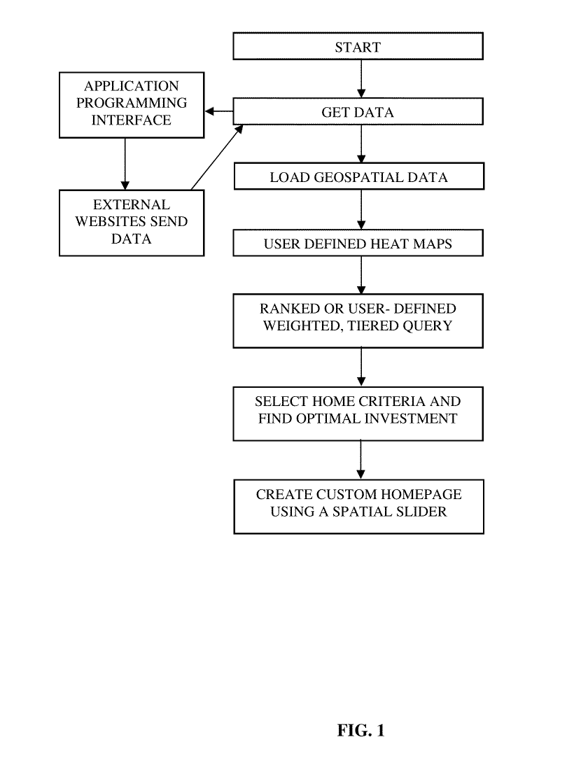

Referring to FIG. 1, a sequence of steps for acquiring geospatial data, compiling the geospatial data and providing an interactive visual representation of the geospatial data based on user input are illustration. Start defines where input data and output data are planned and investigated. Input data can be acquired from one or more vendors. Each of the vendors provides historical geospatial data under multiple categories. The historical geospatial data comprises data acquired over multiple time periods. The categories comprise national variables, metro market datasets, monthly/quarterly datasets and all national property datasets. From the acquired and evaluated geospatial data multiple variables are acquired. The variables are compiled into individual geospatial datasets and a standard database. Get data refers to capturing and compiling each and every variable below, weekly, monthly, and/or quarterly data. The variables comprise Census Block, Census Block Group, Census Tract, Zip Codes, neighborhoods, cities, counties, metro markets and states.

Each geospatial dataset comprises a plurality of geospatial database rows and database columns. As used herein, the term Census Block comprise over 7,000,000 geospatial database rows, with over 100 columns or variables. As used herein, the term Census Block Group comprises over 209,000 geospatial database rows, with over 300 columns or variables. As used herein, the term Census Tract comprise over 67,000 geospatial database rows, with over 300 columns or variables. As used herein, the term Zip Codes comprise over 43,000 geospatial database rows, with over 300 columns or variables. As used herein, the term neighborhoods comprise over 26,000 geospatial database rows, with over 200 columns or variables. As used herein, the term cities comprise over 25,000 geospatial database rows, with over 200 columns or variables. As used herein, the term counties comprise 3100 geospatial database rows, with over 100 columns or variables. As used herein, the term metro markets comprise over 800 geospatial database rows, with over 100 columns or variables. As used herein, the term states comprise 50 geospatial rows with over 100 columns or variables. Vendors, datasets, vector-based boundary sets, and technology are evaluated, and programming code is developed for integrating data. In an embodiment, the programming code is written in C++.

Consider an example, wherein four vendors, namely, vendor A, vendor B, vendor C, vendor D provide input data. Vendor A provides input data at a cost of $1500 per year, comprising over 70 national variables and must have a minimal of 10 years of historic monthly/ or quarterly datasets. Vendor B provides input data at a cost of $2500 per year comprising metro markets and 250 input variables and a minimal of 5 years of historic data. Vendor C provides input data at a cost of $22000 per year comprising over 340 monthly and/or quarterly datasets and must have a minimal of 5 years of historic data compiled for the census block levels and higher geospatial levels. Vendor D provides input data at a cost of $22000 per year comprising over $100,000 per year comprising all national property datasets are clustered into a geospatial database every week/month/ or quarter.

Variables are captured and compiled into all geospatial datasets, for each block, block group, census tract, zip code and higher geospatial levels. The geospatial databases are linked by a string, or a string of digital numbers assigned to each geospatial datasets. For example, a hypothetical Census Block number of 011797619144001 fits into its corresponding Census Block Group number of 0117976191440. In an embodiment, building a 12-month predictive model for a geospatial level requires three times the amount of data as the desired time period, For example, a 12-month predictive model requires geospatial data for over 36 months. In another example, a 24-month predictive model requires over 72 months of geospatial data for each census block, census block group, census tract, zip code and higher geospatial data.

Data may be acquired in multiple ways. For example, really simple syndication (RSS) feeds that are purchased and compiled in geospatial databases, direct purchases from vendors, compiling and clustering of real estate datasets such as inventory or the number of foreclosures, into geospatial datasets from vendors, etc. The data is compiled into two databases, namely, spatial database and a standard MySql database. The compilation of data is a critical step since the two databases do not directly communicate to each other and are not instantly query able by a user. In an embodiment, the geospatial database is combined with the standard SQL database.

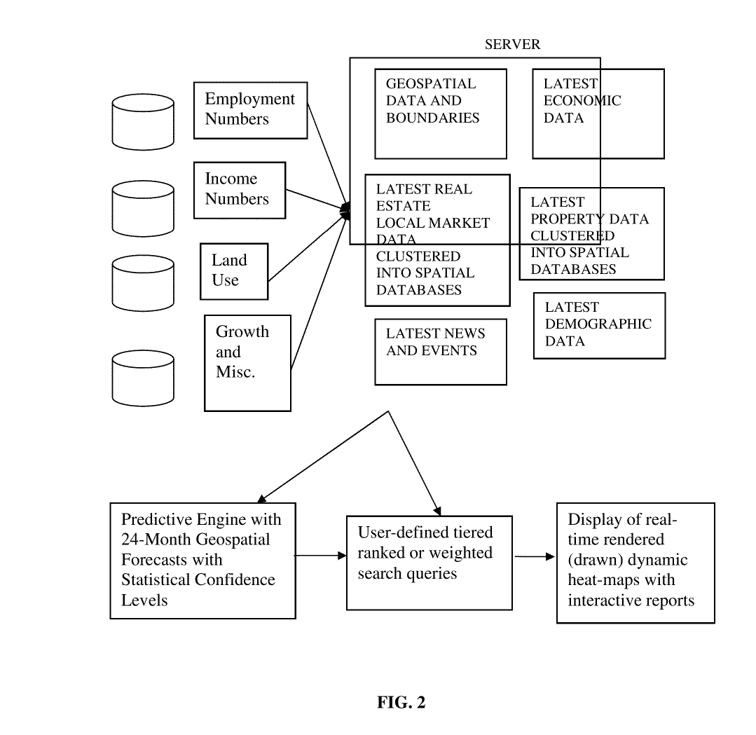

FIG. 2 illustrates a system for loading of geospatial data. As used herein, the term employment numbers comprise the latest: unemployment rates, new jobs, job growth, types and sectors of job growth, new or re-hired, pre-hired employees, etc. The data sets acquired from vendors and verified and back tested for reliability. As used herein the term income numbers comprise median income, market basket, weekly expenses, disposable income, etc. As used herein, the term land user comprise size of buildable lance, permits issued, permits approved, amount of vacant land, etc. The data is purchased from vendors, verified and back tested for reliability. As used herein, the term, growth and misc comprise over 300 other variables, for example, population changes, births and deaths, changes of addresses, migration, changes in regional policies, tax rates. The data is purchased from vendors, verified and back tested for reliability.

Predictive engines are used with 24-month geospatial forecasts with statistical confidence levels. In an embodiment, the predictive engines are also used with 36 month geospatial forecasts. The system as illustrated in FIG. 2 uses 3-9 core mathematical processes, with constant evaluation as to identify the optimal combination. The mathematical processes comprise standard regression models on geospatial data and boundaries, lattés demographic data, latest economic data, latest property data clustered into spatial databases, latest real estate and local market data clustered into geospatial databases and latest news and events. For example, the mathematical processes comprise standard regression models for each Block, for all over 3,000,000 geospatial boundary levels. A formula, Y=f(X, B) is used. B in the formula denotes the unknown or the forecast. X is an independent variable. Y is the dependent variables. Non linear regressions is similar, but the relationship within datasets are independent, Geospatial temporal formulae are well documented by universities and take into account changes over distance and time not present in a particular block, tract, or state. The front end of the predictive engine is an expert system, obtained over years over development and back testing. The expert system comprises different combination of mathematical processes, hack testing of forecast for all geospatial areas and refining the expert system and rules to enhance accuracy.

Different methods or combinations of mathematical processes are tested to enhance the predictive model. The methods are re-tested every week, month, and/or quarter to enhance the accuracy of the predictive engine. In addition, the expert system comprises over a hundred geospatial rules, formulated over time to optimize the forecasts. For example, consider a rules, if the median income changed in a census block, namely x is greater than 40% during the last month or quarter, and the change in the corresponding census tract for census block x, is less than 30% during the previous month and/or quarter, that the change in the median income for census block x, is reduced in weight by 25%. Each of the rules is a part of the proprietary technology developed and tested over the years. Other rules are for example, non-direct price influences, for example, factors that are seasonal. These rules can only be viewed after years of back-testing and observations. For example, if 40% of the population within a neighborhood migrates one month and/or quarter, are these snowbirds or vacationers or are these people moving because of a plant closure. These seasonal adjustment are rules set into the expert System, based upon observation and percentage changes, as to which blocks lose populations, that are only temporary. Each of these rules change for thousands of spatial areas.

User defined heat maps as mentioned in FIG. 1 refers to the visual representation of dynamic geospatial maps as heat maps. The dynamic geospatial maps are generated from the geospatial forecast. Heat maps can be represented by a range of 3 colors to 10 colors. The heat maps are rendered by the following sequence of steps. The user enters an address-online. The system finds and assigns the latitude and longitude coordinates for the address. The user chooses what geospatial level he wants to view for comparison with a larger geospatial level. A default setting may, for example, compare a corresponding Census Block Group to a matching Metro Market. For example, the user types in 101 Main St, Chicago, Ill. The system matches 101 Main St to its Census Block Group, and show a dynamic heat map of the Chicago Metro Market. Hence the user acquires information about the properties in Chicago. The system matches all the corresponding higher geospatial levels. With the string, mentioned above, for example, census block to county. A query is sent to the geospatial databases and the system ranks the defined Census Block Groups. The query comprises hidden code that sends rules to the databases enabling the user to view the results on the user interface. Depending on which of then ten Colors are selected, rankings are now sent to a separate sub-table, and the vector-based heat maps are drawn in real-time in the user's browser, based upon the ranking of the sub-table. These sub-tables are created, to speed up performance for the user. In an embodiment, the sub-tables can also be saved and exported for later use, so even a blind person can also access these new geospatial datasets.

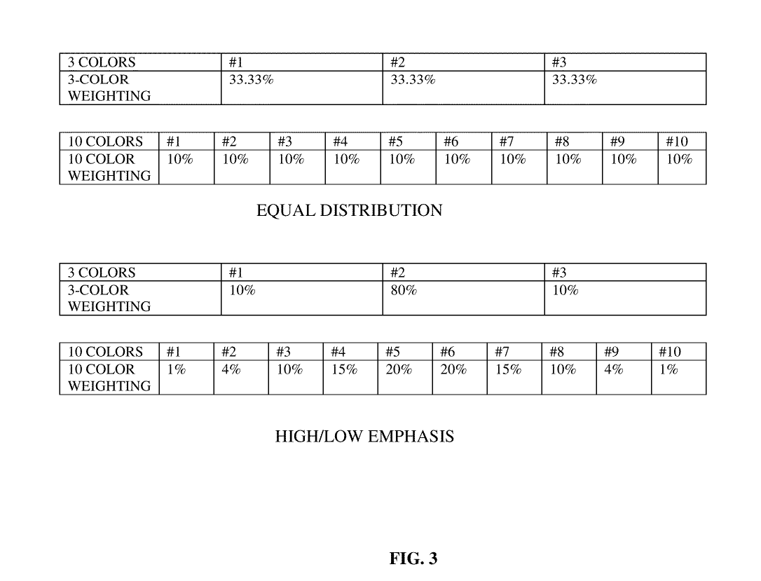

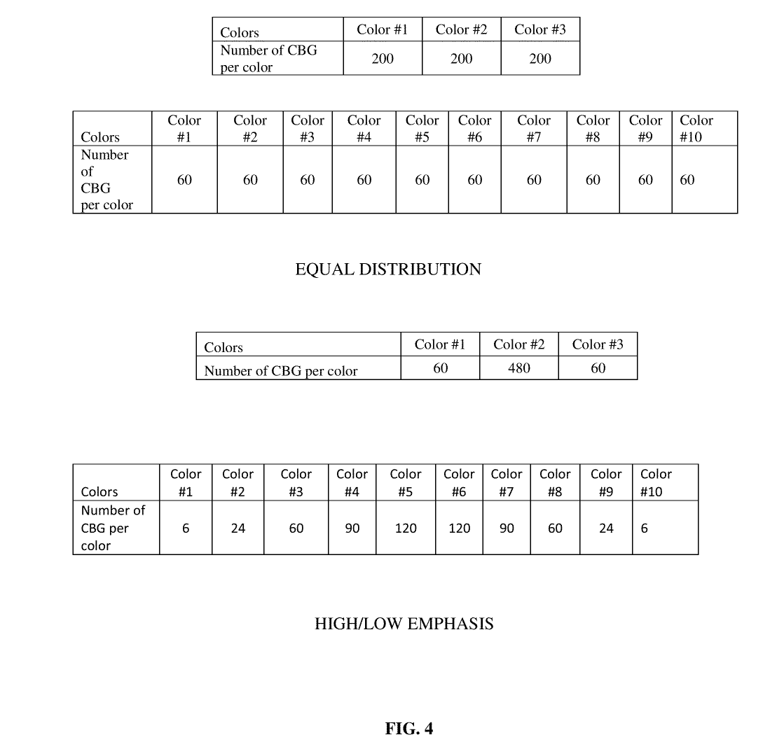

The user chooses a higher geospatial level at each comparison. Referring to FIG. 3 and FIG. 4. the tables show example on how the colors are determined from the query to the geospatial database of weekly to monthly datasets and rendered in the real time dynamic maps. The color ranges are also automatically sent to the legend. As depicted in FIG. 3 and FIG. 4, there are two types of color distributions within the real time heat maps, equal distribution and high/low emphasis. FIG. 3 represents the color table for the Census Block Group (CBG) or “Hyper-Local” in the geospatial slider image. FIG. 4 represents the color table for Census Block Group (CBG) dynamic map based upon a Metro Market of 600 CBG's.

The benefit to the user in viewing the real time dynamic maps using the high/low emphasis ranges is that the user can instantly view, find, and export the dynamic maps into a table. The top 1% or the top 6 of 600 CBG's or for any set of geospatial datasets. The list of geospatial datasets comprise census block (CB) with 209,000 per each geospatial sets, Census Block Group (CBG) with 67,000 per each geospatial sets, zip code (ZC) with 43,000 per each geospatial sets, neighborhood with 28,000 per each geospatial sets, city with 22,000 per each geospatial sets, counties with 3,100 per each geospatial sets, metro markets with 400 per each geospatial sets, states with 52 per each geospatial sets and national with 1 per each geospatial set.

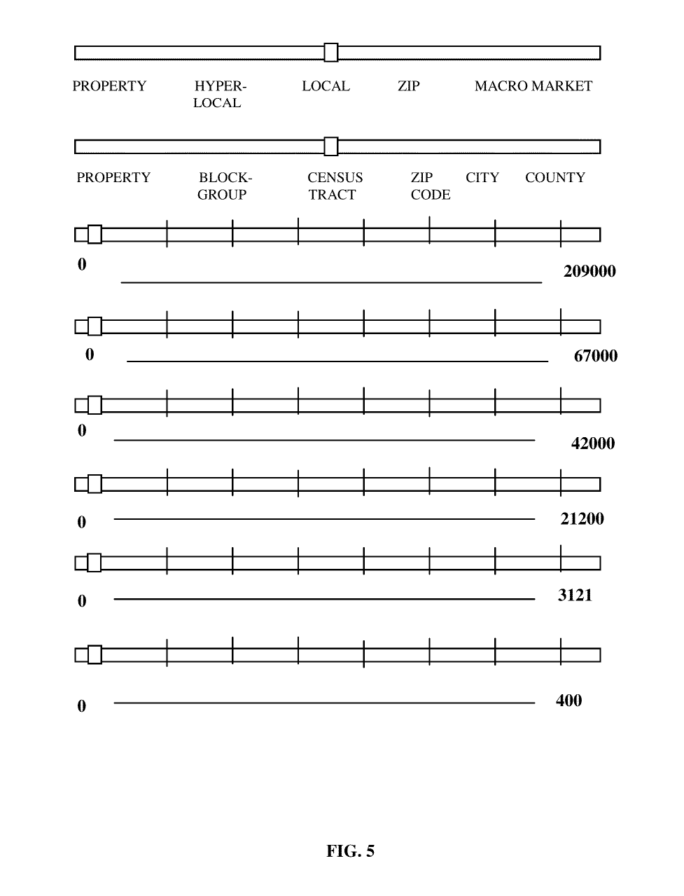

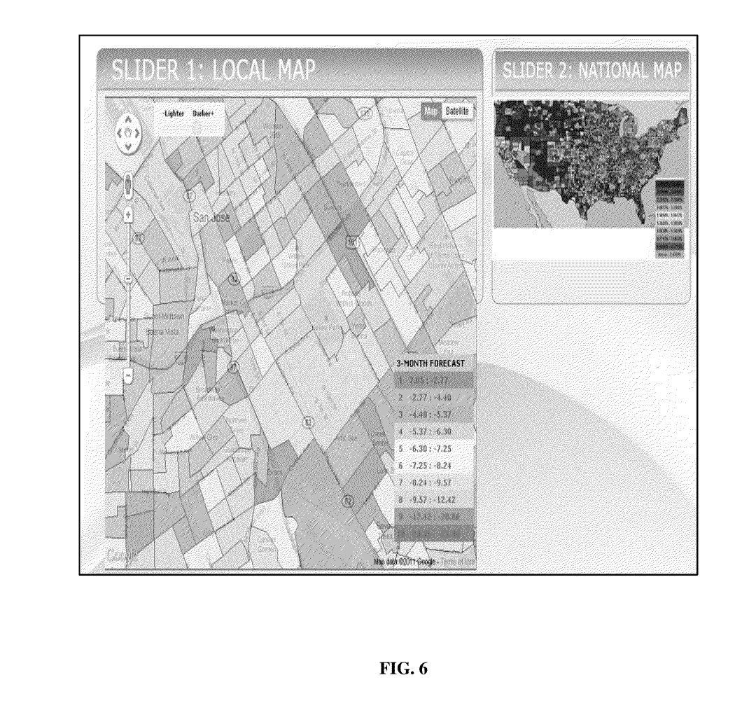

FIG. 5 represents different types of geospatial sliders. The different types of sliders comprise block group slider census tract slider, zip code slider, city slider, county slider, and metro market slider. The different sliders allow the user to instantly query the database using a visual element resulting in the system dynamically drawing a heat map. The user slides the spatial slider allowing the user to dynamically access all spatial boundary information via a report, a form, a web page or a dynamic map. The slider moves from one geospatial to another. Hence heat maps are instantly rendered and drawn based on the user preference and choice. For example, the slider moves from property to census block to census block group to zip code to neighborhood to city to metro market to state to national. User defined dynamic geospatial maps are rendered as heat maps. Each variable is represented in the range of 3 colors to 10 colors. The sliders allow maps to be drawn in real time as illustrated in FIG. 6.

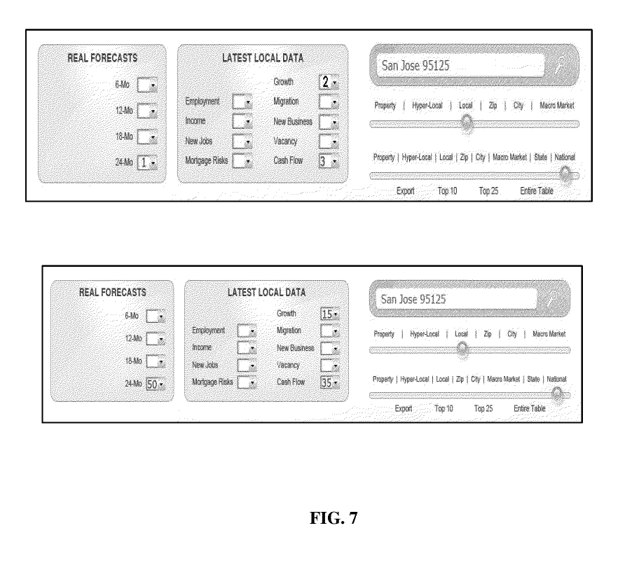

Ranked or user defined weighted tiered query as referred to in FIG. 1 relates to the user provided with a user defined ranked or tiered weighted search comprising multiple choices for generating the dynamic geospatial maps as illustrated in FIG. 7. FIG. 7 shows how a user who needs to find a geospatial area, a block or a block group, that has a high expected forecast changes in appreciation, with good cash flow, and good growth. This user picks these as 1, 2, and 3. The query would be sent to the geospatial database, thus instantly render the maps based upon what the user wants. FIG. 7 also shows an advanced option or the tiered weighted search. In the tiered weighted search, the user can insert numbers of 50% or 60%. This option is mostly for businesses. The more advanced option is the tiered weighted search. In this case 1, 2 and 3 were replaced by 50%, 35% and 15%.

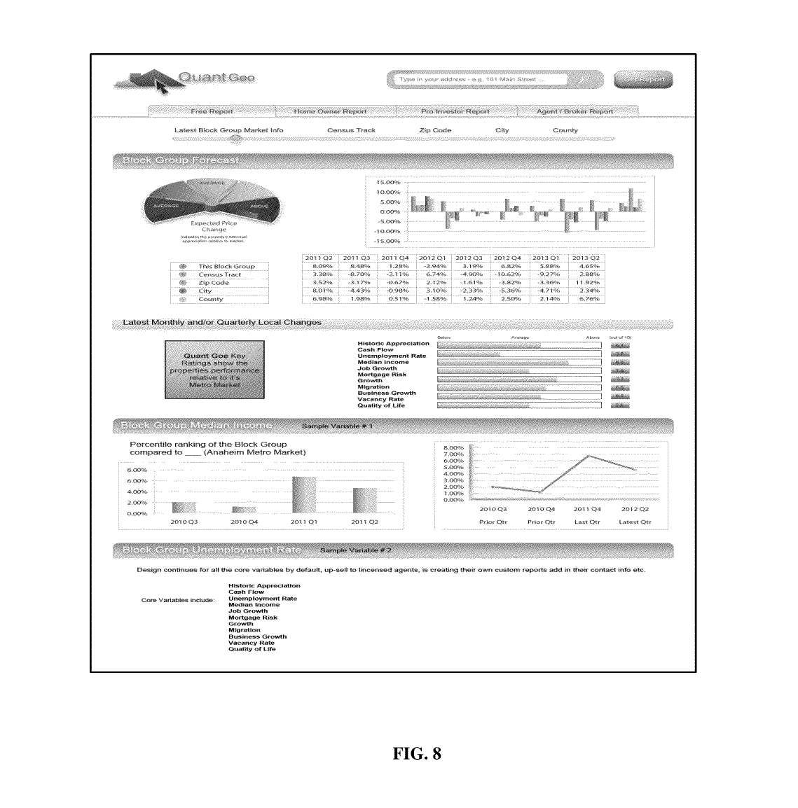

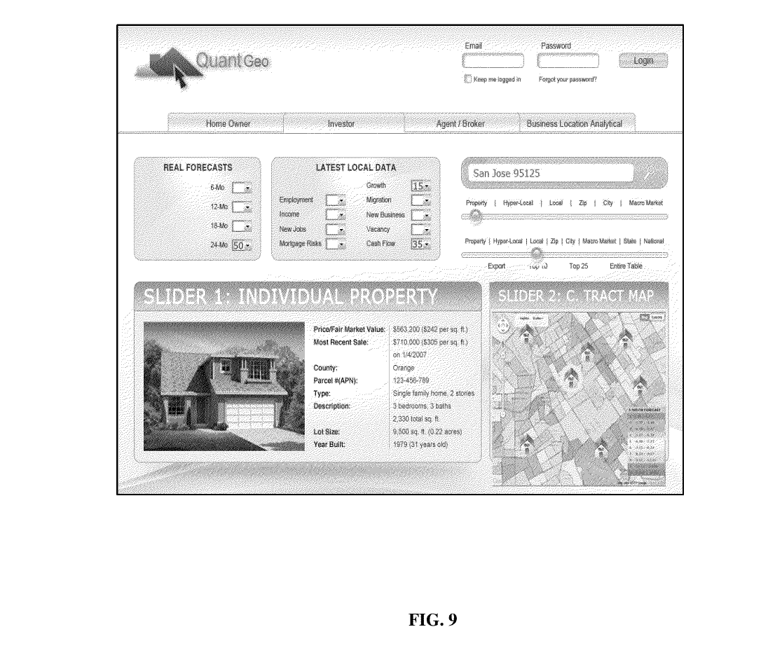

Referring to FIG. 8, the geospatial slider also allows for user-defined interactive reports with one geospatial slider. Another option is user-defined interactive reports with two geospatial sliders as illustrated in FIG. 9.

A core problem for property sales people, for example, agents, brokers, realtors, etc. of all scoring type reports, and reports that have forecasts, is that if the generated score is low then the forecast is negative. Negative forecasts do not help the salesperson. Additionally, for the real estate appraiser may only want a report that just shows the latest local treads, and not the forecasts. Thus, embodiments may include the following reports:

Report type 1 offers geospatial datasets that consumers are familiar. The geospatial datasets are positive in the above 75% percentile. Thus block, block groups, and census tracts are not present in this report. Only data that is positive is reported for these more common terms. For example, for a report for zip code 95125 that is comparing this zip code to its County of Santa Clara County, if the latest job growth trend in Zip Code 95125 is less than 75% it is not in the report, if it is greater, then it is in the report. The report goes through all different types of scenarios and relationship, and this query to the database, shows a report with dynamically rendered heat maps in this report. Thus the salesperson can go sell and get listings, and only lay emphasis the positive.

Report type 2 is similar to report type 1, but includes all geospatial datasets. Report type 3 is similar to report type 2, but the agent/broker/realtor can choose the exact percentile, for example, 67.5% for this report. Report type 4 is where the individual agent/broker/realtor, who are familiar with geospatial datasets, can look at all the data, and choose what date to show in the report. For example, in report 1, the agent, broker or realtor may also want to show a variable within the report that is less than 75%, hence they have this option. Report type 5 is a report for appraisers, which does not include predictive analytics and is a value added feature to their standard appraisal reports. These standard appraisal reports typically describe if the market is bad, fair, average or good, which does not help underwriters in assessing risk.

Report type 6 is an underwriter's report, which is similar to a basic report illustrated above, but also contains standard property datasets.

Report type 7 is a report that traders for mortgage backed securities (MBS) would use to adequately assess future risks and returns for these securities. It may also be possible to add to the invention disclosed herein and predictive analytics to trading platforms such as Bloomberg or Reuters. Report type 8 is a report and online system that asses risk for real estate securities post origination. This assessment is only done after the security is originated and sold. The buyer of these securities then can use a risk assessment tool, to determine if they should hold or sell this security during the holding period; while monitor local block, block group, and census tract changes that affect the risk of their security and portfolio.

Based on the reports the user selects the home criteria as referred to in FIG. 1 and finds the optimal investment. The optimal investment is obtained from the tiered weighted search query in combination with the user defined query. Additionally the user is provided with options to create a customized homepage based on the user's preferences. The user is provided with a spatial slider, using which the content on the homepage is altered.

In an embodiment, multiple external websites send input data to the server. In response the present invention provides an application programming interface to the external websites to facililate user experience on the external website. In another embodiment, the present invention can be displayed on other external websites either as a widget, an application or an iframe. For example, dating websites can display a widget of the present invention. When a user clicks the widget, a heat map is generated to display the number of singles in a geographical area.

1. A computer-implemented method for acquiring geospatial data, compiling said geospatial data and providing interactive visual representation of said geospatial data based on user input, the method comprising:
(a) Acquiring and evaluating geospatial data from one or more vendors, wherein each of said one or more vendors provides historical geospatial data under a plurality of categories, and wherein said categories comprise national variables, metro market datasets, monthly/quarterly datasets, and all national property datasets;
(b) Compiling a plurality of variables from said acquired and evaluated geospatial data into individual geospatial datasets and a standard database, wherein said plurality of geospatial datasets comprise Census Block, Census Block Group, Census Tract, Zip Codes, neighborhoods, cities, counties, metro markets and states;
(c) Loading a 24 month geospatial forecast with statistical confidence based on a plurality of mathematical processes performed on said individual geospatial datasets by a predictive engine;
(d) Providing a user, user-defined ranked or tiered weighted searches comprising a plurality of choices for generating said dynamic geospatial maps, wherein said dynamic geospatial maps are visually represented as heat maps, wherein said dynamic geospatial maps are generated from said geospatial forecast;
(e) Allowing said user to slide a spatial slider, wherein said user can dynamically access all spatial boundary information in one of a report, a form, a web page and a dynamic map.

2. The method of claim 1 wherein, said historical geospatial data comprise data acquired over multiple time periods.

3. The method of claim 1 wherein, each geospatial dataset comprises a plurality of geospatial database rows and database columns.

4. The method of claim 1 wherein, geospatial data can be acquired in one or more of:
Web feed formats compiled in geospatial databases;
Direct purchases from vendors;
Clustering of real estate datasets comprising one or more of inventory and number of foreclosures, into geospatial datasets.

5. The method of claim 1, wherein said individual geospatial datasets and said standard databases do not communicate with each other.

6. The method of claim 1 wherein, said mathematical processes comprise standard regression models on geospatial data and boundaries, latest demographic data latest economic data, latest property data clustered into spatial databases, latest real estate and local market data clustered into geospatial database, and latest news and events wherein a formula Y=f(X.B) is used, wherein B denotes the unknown or forecast, X is the independent variables and Y is the dependent variables

7. The method of claim 1, wherein said predictive engine comprises an expert system, wherein said expert system comprises one or more of combinations of mathematical processes, a plurality of geospatial rules formulated over time to optimize said forecasts and non direct price factors.

8. The method of claim 1, wherein said generation of dynamic geospatial maps and visual representation of heat maps comprise the steps of:
Accepting a physical address from a user;
Assigning latitude and longitude coordinates for said physical address;
Accepting and input from said user input comprising a geospatial level, wherein said user requests comparison of said geospatial level with a larger geospatial level;
Matching all corresponding geospatial levels with said geospatial level;
Querying said individual geospatial dataset with said input from said user;
Ranking said geospatial datasets and visually representing said geospatial datasets as heat maps using a plurality of colors selected by said user;

9. The method of claim 8, wherein said generation of dynamic geospatial maps visual representation of heat maps is extended to one or more external websites.
